(19) United States
(12) Patent Application Publication
(10) Pub. No.: US 2019/0190981 A1
(43) Pub. Date: Jun. 20, 2019

(54) INTELLIGENT TRACE GENERATION FROM COMPACT TRANSACTION RUNTIME DATA

(71) Applicant: CA, Inc., New York, NY (US)

(72) Inventors: Ramesh Mani, Fremont, CA (US); Anand Krishnamurthy, Fremont, CA (US)

(21) Appl. No.: 15/844,491

(22) Filed: Dec. 15, 2017

(51) Int. Cl. H04L 29/08; H04L 12/26; G06F 9/54

(52) U.S. Cl. CPC H04L 67/10; G06F 9/54; H04L 43/04

(57) ABSTRACT

To allow trace generation regardless of the complexity of a distributed application, agents across a distributed application split transaction information into static data that identifies the subroutines of a software component and compact runtime data that is recorded for per transaction. A single instance of the static data is maintained for a software component while the compact runtime data is maintained for per transaction that invokes the software component. When a transaction satisfies a trace filter, the filter initiation component includes in a software component invocation for a subsequent transaction an identifier of the previous transaction that satisfied the trace filter. This transaction identifier propagates across the downstream components and causes the downstream components to generate and send trace segments constructed from the previously recorded runtime data for the identified previous transaction and the static subroutine identifying data for the respective component.

### BACKGROUND

The disclosure generally relates to the field of data processing, and more particularly to software development, installation, and management.

Diagnosis of issues in a distributed application typically involves analyzing an execution path, also referred to as a trace, of a transaction and runtime data associated with the trace. A distributed application that has been instrumented includes instruments (also “agents”) that capture runtime information and caller-callee information across software components of the distributed application. A trace can be created by correlating this captured information across the agents of software components involved in a transaction, and the trace is then provided to a monitoring system/application. A criterion that indicates when a trace should be created for a transaction is set to limit trace generation to transactions of interest (e.g., transactions that take more than x seconds). Since the criterion limits trace generation to those of interest, the mechanism to apply the criterion is referred to as a filter. The set criterion typically corresponds to a performance problem.

### BRIEF DESCRIPTION OF THE DRAWINGS

Embodiments of the disclosure may be better understood by referencing the accompanying drawings.

FIG. 1 is a diagram of distributed application components capturing transaction data in compact form and intelligently reporting trace segments.

FIG. 2 is a flowchart of example operations for compact transaction data capture for distributed application transaction tracing.

FIG. 3 is a flowchart of example operations for intelligent trace segment reporting.

FIG. 4 depicts an example computer system with an instrumented software component for compact transaction data recording and intelligent trace segment reporting.

### DESCRIPTION

The description that follows includes example systems, methods, techniques, and program flows that embody embodiments of the disclosure. However, it is understood that this disclosure may be practiced without these specific details. For instance, the description refers to a distributed application component as either program code hosted within a runtime environment or a package of the program code and the runtime environment program code, with a possible intimation that the runtime environment is limited to a Java® virtual machine or a similar runtime environment. However, embodiments are not so limited. As an example, a distributed application component may be program code, whether in one or multiple files, that runs within an operating system without an encapsulating runtime environment or virtual machine. In other instances, well-known instruction instances, protocols, structures and techniques have not been shown in detail in order not to obfuscate the description.

Overview

A distributed application allows a requestor (e.g., user, web service, etc.) to submit a transaction request. The distributed application presents the transaction as a unit of work or a single task, which is actually a series of operations or tasks performed by software components of the distributed application. For instance, an online shopping application provides a purchase item(s) transaction that can include user authentication, multiple databases accesses, and maintaining transaction state data. The series of operations of a transaction can cross hundreds of software components, each of which may make thousands of subroutine calls to implement the transaction. To analyze transaction performance, perform triage, and/or diagnosis of an issue encountered in a transaction, a trace (i.e., execution path) can be used.

A filter for trace generation (“trace filter”) can be set at any of the software components. Whether the trace filter is satisfied or not, will not be known by software components downstream from the software component at which the trace filter is set (“filter initiation component”) unless that is communicated to the downstream components. And that cannot be communicated until the transaction completes, at least with respect to the filter initiation component. Thus, the downstream components would proactively collect information about the transaction and either preserve the collected information until notified that an upstream trace filter was satisfied or continuously transmit the collected information to a monitoring application. For both, the footprint of the collected data and the communication overhead would be too large.

To allow trace generation regardless of the complexity of a distributed application, agents (e.g., a helper thread launched for application monitoring) across a distributed application split transaction information into static data that identifies the subroutines of a software component (“static subroutine identifying data”) and compact runtime data that is recorded for a transaction instance. A single instance of the static subroutine identifying data is maintained for a software component while the compact runtime data is maintained for per transaction that invokes the software component. The static subroutine identifying data is referred to as static because there is a very low likelihood of the subroutines that can be called changing across transactions (e.g., not likely that the classes and or methods of a component will change). The compact runtime data for each transaction is a set of runtime values expressed in compact form (e.g., as integers) for each of the subroutines identified in the static subroutine identifying data that is actually called in a transaction. Maintaining a single instance of the static subroutine identifying data identifying data per software component facilitates representing the runtime data in compact form because the compact runtime data will have integer values that reference appropriate entries in the static method identifying data. This substantially reduces the footprint of the transaction information recorded at a software component for trace generation. Since the footprint of the information for each transaction is small, the agents of the software component can preserve the information across the lives of numerous (e.g., thousands) of transactions. When a transaction satisfies a trace filter, the filter initiation component can include in a software component invocation for a subsequent transaction an identifier of the previous transaction that satisfied the trace filter. This transaction identifier propagates across the downstream components and causes the downstream components to generate and send trace segments constructed from the previously recorded runtime data for the identified previous transaction and the static subroutine identifying data for the respective component.

Example Illustrations

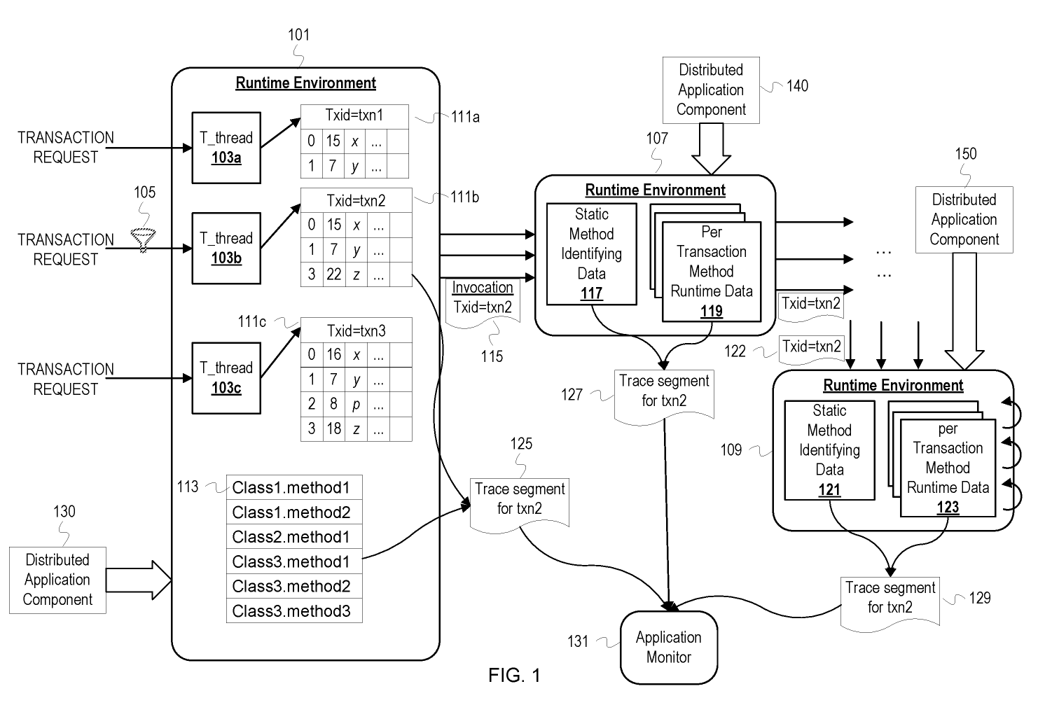

FIG. 1 is a diagram of distributed application components recording captured transaction data in compact form and intelligently supplying trace segments for trace analysis. A distributed application includes a number of components 130, 140, 150 which respectively run within a runtime environment 101, a runtime environment 107, and a runtime environment 109. Numerous transactions can be performed concurrently by the distributed application, but FIG. 1 is limited to depicting three transactions. When a transaction request is received at the runtime environment 101, which is running as a front-end component of the distributed application, the transaction traverses those of the distributed application components that perform tasks relevant to the requested transaction. Traversal of relevant components by the transaction means that the relevant components will invoke each other as programmed to carry out the transaction dependent upon variables that can influence the transaction (e.g., type of transaction, user, infrastructure state, etc.). An application monitor 131 monitors the distributed application.

Each runtime environment 101, 107, 109 manages multiple threads. To support concurrency, a thread can be launched for each requested transaction. A thread launched for a transaction is referred to herein as a transaction thread, and identified in FIG. 1 as “T_thread.” To monitor the distributed application, the components have been instrumented with program code to capture data about transactions that traverse the component. Examples of the captured data include names of called subroutines, start time and end time, execution time of a called subroutine, and memory consumed during execution of a subroutine. Each runtime environment 101, 107, 109 also manages helper threads, which are not depicted due to space constraints in the drawings. Although a transaction thread could record captured runtime data, this adds overhead to the transaction. Instead, each instrument writes out transaction data to a specified location (e.g., an allocated portion of method memory area). A helper thread or “monitoring agent” detects the write and processes the captured data.

Each of the runtime environments load distributed application components (e.g., .java files) and create corresponding static structures that describe the defined aspects of the loaded application component. In some cases, the components and the runtime environment are provided as a package for deployment. After the runtime environment 101 loads the application component 130, it creates a static structure 113 with data that identifies the subroutines of the application component 130 (“static method identifying data”). The static structure 113 identifies 6 subroutines across 3 classes. Real world component will more likely have thousands of methods across hundreds of classes. The distributed application component 130 defines a class Class1 with 2 defined methods, “Class1.method1” and “Class1.method 2”; a second class Class2 with a method “Class2.method1;” and a third class Class3 with 3 methods “Class3.method1,” “Class3.method2,” and “Class3.method3.” After loading the distributed application component 140, the runtime environment 107 generates a static structure with static method identifying data 117. After loading the distributed application component 150, the runtime environment 109 generates a static structure with static method identifying data 121.

As the runtime environment 101 receives transaction requests, it instantiates transaction threads. In FIG. 1, the runtime environment 101 instantiates T_threads 103a, 103b, 103c for respective ones of the transaction requests based on detection of the transaction requests. The T_thread 103a identifies its transaction with transaction identifier txn1. A global counter accessible by T_threads 103a, 103b, 103c can be maintained to uniquely identify each transaction initiated at the runtime environment 101. The description refers to the T_threads as creating the runtime data structures and recording captured runtime data values into the runtime data structures, but embodiments can use helper threads instead of the transaction threads to record the captured runtime data. T_thread 103a creates a runtime data structure 111a for recording runtime data of the transaction txn1. For the transaction txn1, the methods Class1.method1 and Class1.method2 are executed. T_thread 103a records runtime data captured for Class1.method1 and records runtime data captured for Class1.method2 into the runtime data structure 111a. T_thread 103a sets an index value that maps the recorded runtime data to the corresponding entry of the method in the static structure 113. For this illustration, the T_thread 103a sets an index value of 0 for the runtime data captured for Class1.method1 and an index value of 1 for Class1.method2.

For the transaction txn2, the methods Class1.method1, Class1.method2, and Class3.method1 are executed. T_thread 103b records runtime data captured for each of the methods into a runtime data structure 111b generated for the transaction txn2. The T_thread 103b sets index values 0, 1, and 3, respectively in the first, second, and third entries of the runtime data structure 111b.

For the transaction txn3, the methods Class1.method1, Class1.method2, Class2.method1, and Class3.method1 are executed. T_thread 103c records runtime data captured for each of the methods into a runtime data structure 111c generated for the transaction txn3. The T_thread 103c sets index values 0, 1, 2, and 3, respectively in the first, second, third, and fourth entries of the runtime data structure 111c.

As the transactions traverse the runtime environments downstream from the runtime environment 101, their transaction threads generate runtime data structures and record runtime data for the instrumented methods that are invoked in a corresponding transaction. The transaction identifier assigned to each transaction travels with the invocations for consistency across the components. The runtime data structures with the recorded runtime data values will be referred to in aggregate as “per transaction method runtime data.” In the runtime environment 107, transaction threads generate per transaction method runtime data 119. In the runtime environment 109, the transaction threads generate per transaction method runtime data 123. The transaction traverses the application components within the runtime environments in both directions. The return arrows on the right edge of the runtime environment 109 indicate that the distributed application component 150 loaded into the runtime environment 109 is the last node in the execution paths of the requested transactions in this example illustration. Since methods can be executed as the transaction traverses back to the initiating component, threads can continue recording captured runtime data for the transactions on the return traversal.

In FIG. 1, a trace filter 105 is triggered (i.e., a criterion is satisfied) by the transaction txn2. This is determined when transaction txn2 completes at the runtime environment 101. The T_thread 103b updates a listing of transactions that have triggered the trace filter to include the identifier txn2. To cause generation of a trace for the transaction txn2, the identifier txn2 is included in a next invocation of a downstream component for a transaction. Thus, the next invocation will include both an identifier of current transaction and one or more identifiers of one or more previous transactions that triggered the trace filter. For this illustration, it is assumed that the transaction request for the transaction txn3 is detected after the T_thread 103b determines that the trace filter 105 has been triggered by the transaction txn2. So, the transaction txn3 is the “next” transaction for notifying downstream components that a trace for txn2 is to be created and sent to a defined destination that identifies the application monitor 131. When the T_thread 103c invokes the downstream component 140 in the runtime environment 107, an invocation 115 includes the transaction identifier txn2 (e.g., in a header of a remote method invocation or header of a simple object access protocol (SOAP) message). The invocation 115 also includes the transaction identifier txn3 (i.e., the current transaction), but it is not depicted.

Based on detection of the trace filter 105 being triggered, a helper thread in the runtime environment 101 generates a trace segment 125 from the static structure 113 and the runtime data structure 111b. A segment of a trace is generated since the component's visibility of the trace is limited to incoming invocations, internal invocations, and outgoing invocations. To create the trace segment 125, a helper thread uses the static structure 113 and the runtime data structure 111b to describe caller-callee relationships with the method names in the static structure and associates corresponding ones of the runtime data values from the runtime data structure 111b. The trace segment 125 is then communicated to the application monitor 131 in association with the transaction identifier txn2.

When a transaction thread for the transaction txn3 in the runtime environment 107 detects that the incoming invocation 115 identifies a previous transaction that has triggered a trace filter, the transaction thread caches the previous transaction identifier (e.g., writes it into a data structure for previous transaction identifiers in memory of a runtime environment). A helper thread detects the cached transaction identifier and generates a trace segment 127 for the identified transaction txn2. The helper thread uses the static method identifying data 117 and the one of the per transaction method runtime data 119 that corresponds to the transaction txn2 to generate the trace segment 127. The trace segment 127 is then communicated to the application monitor 131.

When a transaction thread of the transaction txn3 in the runtime environment 109 detects that an incoming invocation 122 identifies a previous transaction that has triggered a trace filter, a helper thread generates a trace segment 129 for the identified transaction txn2. The helper thread uses the static method identifying data 121 and the one of the per transaction method runtime data 123 that corresponds to the transaction txn2 to generate the trace segment 129. The trace segment 129 is then communicated to the application monitor 131. The application monitor 131 can then unify the trace segments based on transaction identifier and analyze the resulting trace for the transaction that triggered the trace filter 105.

The description for FIG. 1 distinguishes between the runtime environments that load and host a distributed application component and the distributed application components. A deployment, however, can package the distributed application component (application component program file(s)) together with the runtime environment program code. The different deployment possibilities allow a distributed application component to refer to the application program code or to a runtime environment with the application program code running within it.

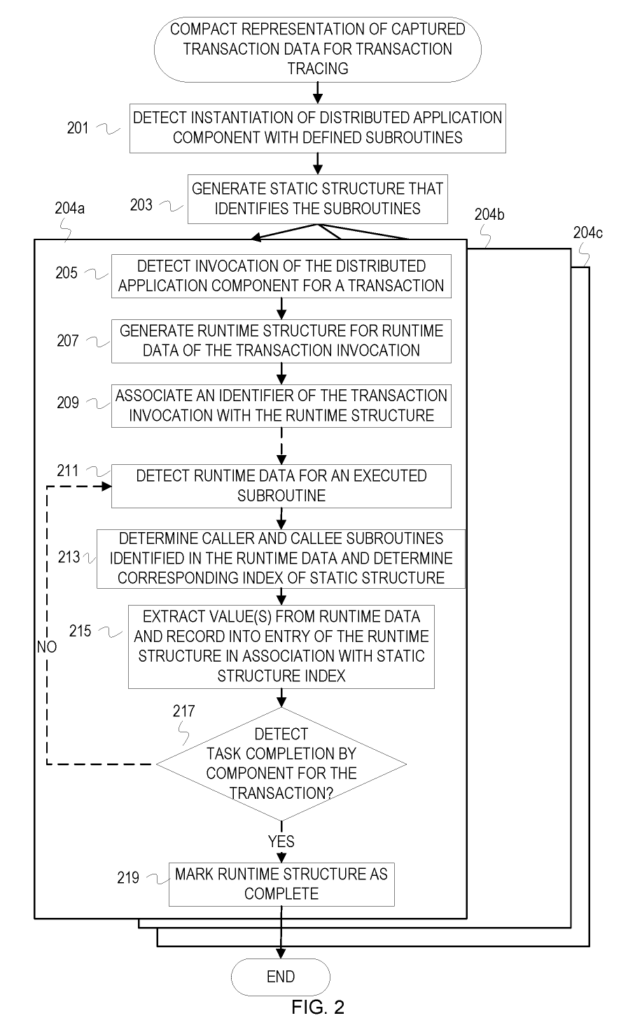

FIG. 2 is a flowchart of example operations for compact representation of captured transaction data for distributed application transaction tracing. The example operations include initial operations that may be performed by a monitoring agent (e.g., an instance of instrumentation added to application program code). FIG. 2 includes the example operations that would occur for a runtime environment (e.g., a Java virtual machine) and depicts blank blocks 204b, 204c to illustrate that the operations in 204a would be performed for each transaction thread.

When a distributed application component is initially loaded and run (instantiated), a monitoring agent(s) is instantiated. The monitoring agent detects the instantiation of the distributed application component (201). The distributed application component will have defined subroutines (e.g., methods, functions, etc.). Based on detecting the instantiation of the distributed application component, the monitoring agent generates a static structure that identifies the subroutines of the distributed component (203). The structure is referred to as “static” because the subroutines defined in the distributed application component are static regardless of transactions. The monitoring agent can determine names of the subroutines by parsing the distributed application component file(s) before they are compiled into bytecodes. In another embodiment, the monitoring agent reads a listing of subroutines that is provided by the distributed application component. The static structure is written to a memory area that will be accessible to threads across or independent of transactions.

Eventually, an invocation of the distributed application component will be received at a host of the distributed application component based on a transaction request, which may be received at the host or an upstream host. The transaction thread can detect the invocation of the distributed application component for a transaction based on the transaction thread being instantiated (205). In some embodiments, the transaction thread can write a transaction identifier into a memory location that is monitored by a helper thread. The helper thread detects invocation of the distributed application component when it detects the transaction identifier in the memory location. Additionally, the transaction thread can spawn or awaken a helper thread for generation and maintenance of a runtime data structure. Based on detecting invocation of the distributed application component, the transaction thread generates a runtime structure for runtime data (“runtime data structure”) captured for the transaction (207). The transaction thread associates the transaction identifier with the runtime data structure so that the runtime data structure can be later retrieved with the transaction identifier (209).

Since every subroutine may not be instrumented, runtime data may not be captured for every invoked subroutine of the distributed application component. The helper thread will detect when runtime data is captured for an executed subroutine by detecting an instrument writing the runtime data to a specified memory location (211). The runtime data can be one or more runtime data values. These runtime data values may be integers when captured or converted into integers by the helper thread. The runtime data values can be performance related measurements, a state indicator (e.g., a value that indicates low memory), time value, an event identifier, etc. The runtime data also identifies the executed subroutine and identifies a caller of the subroutine. The helper thread determines from the runtime data a name or identifier of the executed subroutine and a corresponding index into the static structure (213). The helper thread determines which entry of the static structure identifies the subroutine identified from the captured runtime data. The helper thread then determines the index for that entry. Similarly, the helper thread determines an identifier of a subroutine called by the executed subroutine (callee subroutine) from the runtime data and an index into the entry in the static structure that corresponds to the callee subroutine (213).

The helper thread extracts the runtime data value(s) from the captured runtime data and records the extracted value(s) into an entry of the runtime data structure in association with the determined static structure index (215). The helper thread may convert a runtime data value from the runtime data into a more compact form, such as integer form. The conversion can be guided by pre-defined conversions. For instance, the helper thread can read a table that defines conversions between state identifiers and integers. The conversion may be a data type change, such as a float to integer or string to integer. Positions within each entry will be specified for a particular runtime data value to allow tags or descriptors of the values to be eschewed from the runtime data structure. For example, each entry in the runtime data structure may be organized as (<executed subroutine index>, <start time>, <callee subroutine index>, <end time>).

Eventually, the application distribution component will complete its task(s) for the particular transaction corresponding to the set of operations in 204a. This may be detected by receipt of a communication of a downstream component and sending a response to an upstream component. A helper thread may detect task completion by detecting termination of the transaction thread, assuming that also does not terminate the helper thread. If task(s) completion by the distributed application component for the transaction is detected (217), then the helper thread marks the runtime data structure as complete (219). The marking can be an explicit setting of a bit/flag or implicit marking by changing permission to deny any further writing to the runtime data structure. The complete state or time of permission change can be used to determine when a runtime data structure expires. If task completion is not detected (217), then the helper thread may detect additional runtime data for an executed subroutine (211). A subroutine may be called multiple times and at disparate times for a transaction. The thread records runtime data values for each call into a different entry of the runtime data structure. The thread can compact a sequence of repeated calls to a subroutine by tracking the number of calls and recording an aggregate of the runtime data values (e.g., a total execution time across the repeated calls.)

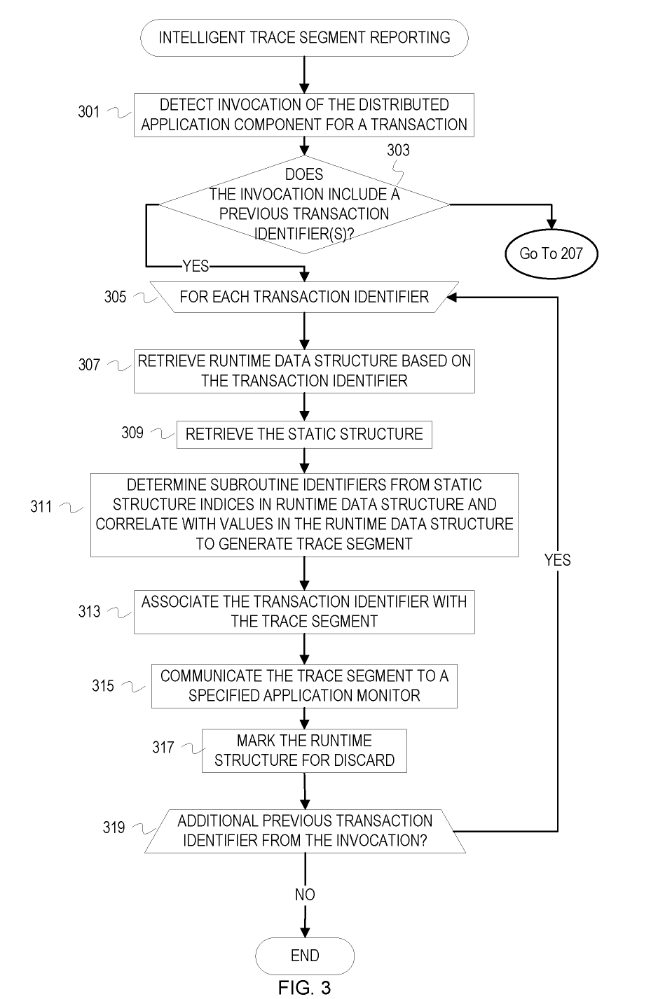

FIG. 3 is a flowchart of example operations for intelligent trace segment reporting. Although the separation of static subroutine identifiers from the per transaction runtime data allows runtime data for numerous transactions without creating a large footprint, it is unlikely that a trace will be created for every transaction. The monitoring agents will limit reporting of trace segments to those transactions that trigger a filter, which avoids wasteful consumption of bandwidth and processing resources.

As in FIG. 2, a transaction thread can detect invocation of the distributed application component based on a transaction request received at a host of the distributed application component (301). Detection can be according to various techniques. The transaction thread can detect the invocation of the distributed application component for a transaction based on the transaction thread being instantiated. The transaction thread can write a transaction identifier into a memory location that is monitored by a helper thread. The helper thread detects invocation of the distributed application component when it detects the transaction identifier in the memory location. Additionally, the transaction thread can spawn or awaken a helper thread. To limit impact on the transaction itself, the process/thread that handles the incoming invocation (which may be the initial transaction request) can copy/write a header from the invocation to a memory location that is accessible to a helper thread. This can also be how the helper thread detects invocation of the distributed application component for a transaction.

After detecting invocation of the distributed application component, the helper thread determines whether the invocation includes a previous transaction identifier(s) (303). The presence of a previous transaction identifier indicates that the identified previous transaction triggered a trace filter. The invocation can include multiple previous transaction identifiers. Regardless of whether the invocation includes a previous transaction identifier(s), the operations beginning at 207 of FIG. 2 are performed. Therefore, there isn't an outgoing arrow labeled NO from the block 303.

If the invocation includes an identifier(s) of a previous transaction(s), then the helper thread begins operations to create and report a trace segment for each previous transaction identifier included in the invocation (305). The helper thread retrieves a runtime data structure based on the previous transaction identifier (307). As previously described, the runtime data structure was associated with a transaction identifier of the ongoing transaction when the runtime data structures were previously created and updated with runtime data of the ongoing transaction. The association allows the helper thread to retrieve the runtime data structure using the identifier of the previous (or already completed) transaction. The helper thread also retrieves the static structure to correlate with the runtime data structure (309).

The helper thread correlates the retrieved structures to generate a trace segment. The helper thread determines subroutine identifiers from the static structure indices in the runtime data structure (311). The helper thread reads an index from an entry in the runtime data structure and then reads the corresponding entry in the static structure to obtain the identifier of the subroutine. The helper thread then correlates the runtime data values of the entry with the subroutine identifier (311). This is done for each entry in the runtime data structure. With the correlated information, the helper thread can generate or construct a trace segment that indicates the caller-callee subroutines and runtime data values of the called subroutines.

After constructing the trace segment, the helper thread associates the previous transaction identifier with the trace segment (313) and communicates the trace segment in association with the previous transaction identifier to a specified application monitor (315). The helper thread may generate a message with the trace segment and a field set to the previous transaction identifier. This can be used by the application monitor to join the trace segments together to form the trace for the identified transaction since each trace segment for a transaction will be associated with the same transaction identifier.

After sending the trace segment (and possibly confirming receipt), the helper thread marks the sent runtime data structure for discard (317). A garbage collection thread of the runtime environment can implement the discard. Embodiments may also set an expiration period for runtime data structures. A helper thread can evaluate a time of permission change to disallow writes or a completion time to an expiration period to determine whether a runtime data structure should be discarded.

The helper thread then determines whether there is an additional previous transaction identifier for which a trace segment is to be constructed (319). The helper thread may have created an array with the previous transaction identifiers from the invocation and iterate over the array. If there is an additional previous transaction identifier, then the helper thread proceeds with performing the operations to generate the trace segment for the identified transaction (305). Otherwise, the process ends.

Variations

The above example illustrations refer to a trace generation criterion that is based on completion of a transaction. However, trace filters may be set based on other criteria that do not require transaction completion. For instance, a trace filter can be set based on detection of an event (e.g., a restart) or performance metric of an ongoing transaction (e.g., age of ongoing transaction). Presumably, the downstream components will have completed their tasks for the transaction despite the transaction being incomplete.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

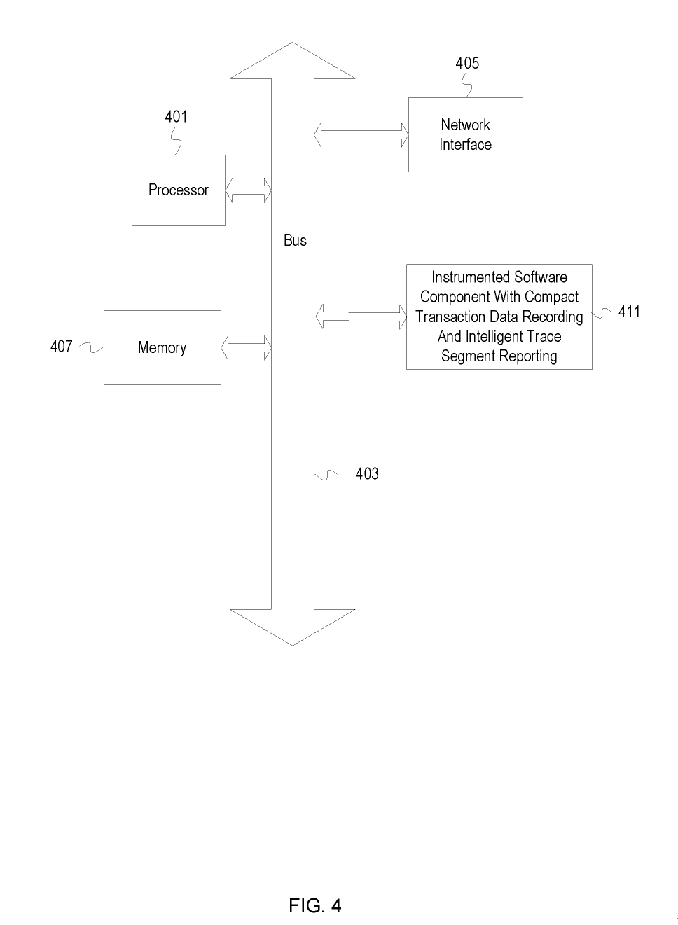

FIG. 4 depicts an example computer system with an instrumented software component for compact transaction data recording and intelligent trace segment reporting. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 and a network interface 405 (e.g., a Fiber Channel interface, an Ethernet interface, an internet small computer system interface, SONET interface, wireless interface, etc.). The system also includes an instrumented software component 411 that has been loaded onto the system. The instrumented software components 411 can be loaded into the memory 407 or a different memory/storage. The instrumented software component 411 includes program code to generate static data that identifies the constituent subroutines of the software component and program code to record in compact form captured runtime data per transaction that invokes the component. If a later invocation identifies a transaction that has already traversed the software component 411, then program code will cause the system to generate a trace segment for the past transaction with the status data and per transaction compact runtime data. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for intelligent trace generation as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on instantiation of each of a plurality of components of an instrumented distributed application, generating a static data structure for each component that identifies the subroutines defined in the component, wherein the instantiation of the plurality of components creates a plurality of component instances;
for each component instance of the plurality of component instances,
generating a runtime data structure for each invocation of the component instance and associating the runtime data structure with a current transaction identifier associated with the invocation;
recording runtime data values for each subroutine executed in each invocation, wherein the runtime data values are recorded into the runtime data structure corresponding to the invocation for which the runtime data values are captured;
for each invocation of the component instance,
determining whether the invocation includes a previous transaction identifier that identifies a previous transaction that previously invoked the component instance; and
based on a determination that the invocation includes a previous transaction identifier, generating a trace segment with the runtime data values in the runtime data structure generated for the invocation and with the static data structure for the component.

2. The method of claim 1, wherein the runtime data values comprise integer values.

3. The method of claim 2 further comprising extracting a first runtime data value from runtime data captured for an executed subroutine and converting the extracted first runtime data value into an integer value.

4. The method of claim 1, wherein the runtime data values for each subroutine executed in each invocation comprise a first index into an entry of the static data structure that identifies the executed subroutine.

5. The method of claim 3, wherein the runtime data values for each subroutine executed in each invocation comprise a second index into an entry of the static data structure that identifies a subroutine called by the executed subroutine.

6. The method of claim 1 further comprising a first thread, for each invocation of each component instance, caching a header of the invocation in a memory location accessible by a second thread for the component instance and the second thread detecting the header in the memory location, wherein determining whether the invocation includes a previous transaction identifier is with the cached header.

7. The method of claim 1 further comprising, for each component instance, recording in a structure previous transaction identifiers that identify transactions that correspond to previous invocations of the component instance and that have satisfied a criterion generating a trace of the instrumented distributed application.

8. The method of claim 8 further comprising:
determining whether the structure is populated based on detection of a current invocation of the component; and
including the previous transaction identifiers that have been recorded into the structure in an invocation of a downstream one of the plurality of component instances.

9. The method of claim 1, wherein generating the trace segment comprises:
correlating the runtime data values of the component instance of the invocation with the static data structure of the component instance based on those of the runtime data values that index into the static data structure.

10. One or more non-transitory machine-readable storage media comprising program code for intelligent trace generation, the program code to:
generate a static data structure that identifies a plurality of subroutines of a first software component of a distributed application;
generate a runtime data structure for each invocation of the first software component;
for each runtime data structure,
record into the runtime data structure runtime data values for each of the plurality of subroutines that is executed for the invocation corresponding to the runtime data structure,
associate an invocation identifier with the runtime data structure, wherein the invocation identifier identifies the invocation corresponding to the runtime data structure;
based on detection that an invocation of the first software component includes a previous invocation identifier that identifies a previous invocation of the first software component, retrieve one of the runtime data structures based on the previous invocation identifier and generate a trace segment for the distributed application with the static data structure and the retrieved runtime data structure.

11. The non-transitory machine-readable media of claim 10, wherein the program code to generate the static data structure is executed based on detection of invocation of the first software component.

12. The non-transitory machine-readable media of claim 10, further comprising program code to:
based on detection of an invocation of the first software component for a first transaction, determine whether transactions of previous invocations of the first software component satisfied a trace generation criterion; and
include in an outgoing invocation of a downstream software component for the first transaction, identifiers of the transactions of the previous invocations that satisfied the trace generation criterion.

13. The non-transitory machine-readable media of claim 10, wherein the program code to generate the trace segment comprises the program code to correlate the runtime data values of the retrieved runtime data structure with the static data structure based on those of the runtime data values that index into the static data structure.

14. The non-transitory machine-readable media of claim 10, wherein the runtime data values are integer values.

15. The non-transitory machine-readable media of claim 14, further comprising program code to convert a runtime data value captured from execution of a subroutine into an integer value.

16. An apparatus comprising:
a processor; and
a machine-readable medium having program code executable by the processor to cause the apparatus to,
generate a static data structure that identifies a plurality of subroutines of a first software component of a distributed application;
generate a runtime data structure for each invocation of the first software component;
for each runtime data structure,
record into the runtime data structure runtime data values for each of the plurality of subroutines that is executed for the invocation corresponding to the runtime data structure,
associate an invocation identifier with the runtime data structure, wherein the invocation identifier identifies the invocation corresponding to the runtime data structure;
based on detection that an invocation of the first software component includes a previous invocation identifier that identifies a previous invocation of the first software component, retrieve one of the runtime data structures based on the previous invocation identifier and generate a trace segment for the distributed application with the static data structure and the retrieved runtime data structure.

17. The apparatus of claim 10, wherein the program code to generate the static data structure is executed based on detection of invocation of the first software component.

18. The apparatus of claim 10, wherein the machine-readable medium further comprises program code executable by the processor to cause the apparatus to:
based on detection of an invocation of the first software component for a first transaction, determine whether transactions of previous invocations of the first software component satisfied a trace generation criterion; and
include in an outgoing invocation of a downstream software component for the first transaction, identifiers of the transactions of the previous invocations that satisfied the trace generation criterion.

19. The apparatus of claim 10, wherein the program code to generate the trace segment comprises the program code executable by the processor to cause the apparatus to correlate the runtime data values of the retrieved runtime data structure with the static data structure based on those of the runtime data values that index into the static data structure.

20. The apparatus of claim 10, wherein the machine-readable medium further comprises program code to convert a runtime data value captured from execution of a subroutine into an integer value.
